(19) United States
(12) Patent Application Publication
(10) Pub. No.: US 2022/0159618 A1
(43) Pub. Date: May 19, 2022

(54) SYSTEMS AND METHODS FOR MIB EXTENSION AND REINTERPRETATION

(71) Applicant: Telefonaktiebolaget LM Ericsson (publ), Stockholm (SE)

(72) Inventors: Stefan PARKVALL, Bromma (SE); Xingqin LIN, Santa Clara, CA (US); Jörg HUSCHKE, Köln (DE)

(21) Appl. No.: 17/440,234

(22) PCT Filed: Mar. 20, 2020
(86) PCT No.: PCT/SE2020/050293

§ 371 Date: Sep. 17, 2021

Related U.S. Application Data
(60) Provisional application No. 62/821,648, filed on Mar. 21, 2019.

(51) Int. Cl. H04W 72/00; H04W 72/04; H04L 5/00; H04L 1/00

(52) U.S. Cl. CPC H04W 72/005; H04L 1/0061; H04L 5/0044; H04W 72/044

(57) ABSTRACT

A method, system and apparatus are disclosed. According to one or more embodiments, a wireless device configured to communicate with a network node is provided. The wireless device includes processing circuitry configured to: receive master information block, MIB, and use a bit of the MIB as an indication of presence of a MIB extension and/or as an instruction to interpret at least a portion of content of the MIB in a predefined way.

### TECHNICAL FIELD

The present disclosure relates to wireless communications, and in particular, to methods and devices interpreting Master Information Block (MIB) content.

### BACKGROUND

System information in the 3rd Generation Partnership Project (3GPP) New Radio (NR) is delivered through a Master Information Block (MIB) and System Information Blocks (SIBs). The MIB is transmitted on a physical channel separate from the SIBs such as a physical broadcast channel (PBCH). The MIB contains a small amount of information, necessary for the wireless device (WD) to be able to receive the remaining system information in the SIBs. Among other pieces of information, the MIB contains the configuration of Control Resource Set 0 (CORESET #0) which describes the structure for receiving the Physical Downlink Control Channel (PDCCH). The structure of the MIB may be specified in standards such as the 3^{rd} Generation Partnership Project (3GPP) wireless communication standards (e.g., 3GPP Technical Specification (TS) 38.211 V15.4.0, Section 7.4.3, 3GPP TS 38.331 V15.4.0, Section 6.2.2), and the format cannot change between releases of the standard without potentially adversely interfering with backwards compatibility. For example, the smallest possible CORESET #0 size in the frequency domain may be 24 resource blocks (RBs) which means that it is not possible to support bandwidths smaller than this, despite a MIB occupying 20 RBs. There may also be other enhancements desirable in the future which may benefit from changes to the MIB. However, currently, most of the bits carried by PBCH has a specific meaning defined in the 3GPP wireless communication standards such as the 3GPP New Radio (NR) standards.

### SUMMARY

Some embodiments advantageously provide methods, systems, and apparatuses for using the reserved bit of a MIB as a flag to indicate whether an “extension MIB’ (eMIB, also referred to as additional MIB and/or MIB extension) is present or as an instruction to interpret at least a portion of content of the MIB. Embodiments also provide for replacing at least a portion of the MIB with content coded in conformance with a second standard that may be different than a first standard, e.g., wireless communication standard, of the MIB. The eMIB or content to be interpreted may be transmitted in a manner such that legacy WDs that operate under a prior/currently known version of a wireless communication standard, e.g., currently known version of the 3GPP wireless communication standard, will not detect the eMIB. In various embodiments, this may be accomplished by using at least one of a different PBCH scrambling sequence than the MIB or a different PBCH cyclic redundancy check (CRC) than the current MIB. Embodiments may also use a different at least one of a primary synchronization signal (PSS) or secondary synchronization signal (SSS) with values not representing a valid combination according to a specification of the MIB to avoid detection by legacy WDs. By extending or interpreting the content of the MIB, new features requiring additional system information can be supported in a backwards-compatible manner. For example, using the described methods and system it is possible to configure a CORESET #0 of a different size than is provided for by the current applicable standards.

According to one aspect of the disclosure, a wireless device configured to communicate with a network node is provided. The wireless device includes processing circuitry configured to: receive master information block, MIB; and use a bit of the MIB as an indication of presence of a MIB extension and/or as an instruction to interpret at least a portion of content of the MIB in a predefined way.

According to one or more embodiments of this aspect, the bit is a reserved bit in the MIB. According to one or more embodiments of this aspect, the processing circuitry is configured to: use the bit of the MIB as an indication of presence of the MIB extension; and receive the MIB extension. According to one or more embodiments of this aspect, the processing circuitry is configured to receive the MIB extension in response to the bit of the MIB having a predefined value. According to one or more embodiments of this aspect, the MIB extension is an additional MIB.

According to one or more embodiments of this aspect, the MIB extension is received via a physical broadcast channel, PBCH. According to one or more embodiments of this aspect, the processing circuitry is configured to: determine a configuration for physical downlink control channel reception based at least on the MIB extension. According to one or more embodiments of this aspect, the MIB defines a CORESET #0 where the MIB extension defines a different CORESET #0 that has a smaller bandwidth than a bandwidth of the CORESET #0 defined by the MIB. According to one or more embodiments of this aspect, a size of the MIB extension is less than a size of the MIB.

According to one or more embodiments of this aspect, a different scrambling sequence is used for the MIB extension than for the MIB. According to one or more embodiments of this aspect, a different CRC is used for the MIB extension than for the MIB. According to one or more embodiments of this aspect, the interpreting of at least the portion of content of the MIB in the predefined way includes at least one of: interpreting at least the portion of content of the MIB in a first predefined way in response to the bit of the MIB having a first value; and interpreting at least the portion of the content of the MIB in a second predefined way in response to the bit of the MIB having a second value.

According to another aspect of the disclosure, a method implemented by a wireless device that is configured to communicate with a network node is provided. Master information block, MIB, is received. A bit of the MIB is used as an indication of presence of a MIB extension and/or as an instruction to interpret at least a portion of content of the MIB in a predefined way.

According to one or more embodiments of this aspect, the bit is a reserved bit in the MIB. According to one or more embodiments of this aspect, the bit of the MIB is used as an indication of presence of the MIB extension, and the MIB extension is received. According to one or more embodiments of this aspect, the MIB extension is received in response to the bit of the MIB having a predefined value. According to one or more embodiments of this aspect, the MIB extension is an additional MIB.

According to one or more embodiments of this aspect, the MIB extension is received via a physical broadcast channel, PBCH. According to one or more embodiments of this aspect, a configuration for physical downlink control channel reception is determined based at least on the MIB extension. According to one or more embodiments of this aspect, the MIB defines a CORESET #0, and the MIB extension defines a different CORESET #0 that has a smaller bandwidth than a bandwidth of the CORESET #0 defined by the MIB. According to one or more embodiments of this aspect, a size of the MIB extension is less than a size of the MIB.

According to one or more embodiments of this aspect, a different scrambling sequence is used for the MIB extension than for the MIB. According to one or more embodiments of this aspect, a different CRC is used for the MIB extension than for the MIB. According to one or more embodiments of this aspect, the interpreting of at least the portion of content of the MIB in the predefined way includes at least one of: interpreting at least the portion of content of the MIB in a first predefined way in response to the bit of the MIB having a first value, and interpreting at least the portion of the content of the MIB in a second predefined way in response to the bit of the MIB having a second value.

According to another aspect of the disclosure, a network node configured to communicate with a wireless device is provided. The network node includes processing circuitry configured to cause transmission of master information block, MIB, where a bit of the MIB providing an indication of presence of a MIB extension and/or an instruction to interpret at least a portion of content of the MIB in a predefined way.

According to one or more embodiments of this aspect, the bit is a reserved bit in the MIB. According to one or more embodiments of this aspect, the bit of the MIB provides an indication of presence of the MIB extension, and where the processing circuitry is further configured to cause transmission of the MIB extension. According to one or more embodiments of this aspect, the processing circuitry is configured to cause transmission of the MIB extension in response to the bit of the MIB having a predefined value.

According to one or more embodiments of this aspect, the MIB extension is an additional MIB. According to one or more embodiments of this aspect, the MIB extension is transmitted via a physical broadcast channel, PBCH. According to one or more embodiments of this aspect, the processing circuitry is configured to cause transmission of a physical downlink control channel, a configuration of the physical downlink control channel being indicated by the MIB extension. According to one or more embodiments of this aspect, the MIB defines a CORESET #0, and where the MIB extension defines a different CORESET #0 that has a smaller bandwidth than a bandwidth of the CORESET #0 defined by the MIB.

According to one or more embodiments of this aspect, a size of the MIB extension is less than a size of the MIB. According to one or more embodiments of this aspect, a different scrambling sequence is used for the MIB extension than for the MIB. According to one or more embodiments of this aspect, a different CRC is used for the MIB extension than for the MIB. According to one or more embodiments of this aspect, the interpreting of at least the portion of content of the MIB in the predefined way includes at least one of: interpreting at least the portion of content of the MIB in a first predefined way in response to the bit of the MIB having a first value, and interpreting at least the portion of the content of the MIB in a second predefined way in response to the bit of the MIB having a second value.

According to another aspect of the disclosure, a method implemented by a network node that configured to communicate with a wireless device is provided. Transmission of master information block, MIB, is caused where a bit of the MIB providing an indication of presence of a MIB extension and/or an instruction to interpret at least a portion of content of the MIB in a predefined way.

According to one or more embodiments of this aspect, the bit is a reserved bit in the MIB. According to one or more embodiments of this aspect, the bit of the MIB provides an indication of presence of the MIB extension, and where transmission of the MIB extension is caused. According to one or more embodiments of this aspect, transmission of the MIB extension is caused in response to the bit of the MIB having a predefined value. According to one or more embodiments of this aspect, the MIB extension is an additional MIB.

According to one or more embodiments of this aspect, the MIB extension is transmitted via a physical broadcast channel, PBCH. According to one or more embodiments of this aspect, transmission of a physical downlink control channel is caused where a configuration of the physical downlink control channel being indicated by the MIB extension. According to one or more embodiments of this aspect, the MIB defines a CORESET #0, and where the MIB extension defines a different CORESET #0 that has a smaller bandwidth than a bandwidth of the CORESET #0 defined by the MIB.

According to one or more embodiments of this aspect, a size of the MIB extension is less than a size of the MIB. According to one or more embodiments of this aspect, a different scrambling sequence is used for the MIB extension than for the MIB. According to one or more embodiments of this aspect, a different CRC is used for the MIB extension than for the MIB. According to one or more embodiments of this aspect, the interpreting of at least the portion of content of the MIB in the predefined way includes at least one of: interpreting at least the portion of content of the MIB in a first predefined way in response to the bit of the MIB having a first value, and interpreting at least the portion of the content of the MIB in a second predefined way in response to the bit of the MIB having a second value.

According to another aspect of the disclosure, a wireless device configured to communicate with a network node is provided. The wireless device includes processing circuitry configured to receive master information block, MIB, and interpret at least a portion of content of the MIB using a first configuration different than a second configuration previously stored for interpreting MIB.

According to one or more embodiments of this aspect, the first configuration corresponds to a first table of at least a first CORESET configuration and the second configuration corresponds to a second table of at least a second CORESET configuration different from at least the first CORESET. According to one or more embodiments of this aspect, the first CORESET configuration corresponds to CORESET #0 with a smaller bandwidth than a bandwidth of the second CORESET configuration. According to one or more embodiments of this aspect, the first configuration corresponds to a first version of a wireless communication standard, and the second configuration corresponds to a second version of the wireless communication standards that is different from the first version.

According to one or more embodiments of this aspect, the MIB associated with the first configuration uses a different scrambling sequence than scrambling sequence associated with the second configuration. According to one or more embodiments of this aspect, the MIB associated with the first configuration uses a different cyclic redundancy check, CRC, than a CRC associated with the second configuration. According to one or more embodiments of this aspect, the MIB associated with the first configuration uses a different primary synchronization signal/primary synchronization signal, PSS/SSS, structure than a PSS/SSS structure associated with the second configuration. According to one or more embodiments of this aspect, the processing circuitry is further configured to receive signaling indicating the first configuration where the first configuration replaces the second configuration.

According to another aspect of the disclosure, a method implemented by a wireless device that is configured to communicate with a network node is provided. Master information block, MIB, is received. At least a portion of content of the MIB is interpreted using a first configuration different than a second configuration previously stored for interpreting MIB.

According to one or more embodiments of this aspect, the first configuration corresponds to a first table of at least a first CORESET configuration and the second configuration corresponds to a second table of at least a second CORESET configuration different from at least the first CORESET. According to one or more embodiments of this aspect, the first CORESET configuration corresponds to CORESET #0 with a smaller bandwidth than a bandwidth of the second CORESET configuration. According to one or more embodiments of this aspect, the first configuration corresponds to a first version of a wireless communication standard, and where the second configuration corresponds to a second version of the wireless communication standards that is different from the first version.

According to one or more embodiments of this aspect, the MIB associated with the first configuration uses a different scrambling sequence than scrambling sequence associated with the second configuration. According to one or more embodiments of this aspect, the MIB associated with the first configuration uses a different cyclic redundancy check, CRC, than a CRC associated with the second configuration According to one or more embodiments of this aspect, the MIB associated with the first configuration uses a different primary synchronization signal/primary synchronization signal, PSS/SSS, structure than a PSS/SSS structure associated with the second configuration. According to one or more embodiments of this aspect, the processing circuitry is further configured to receive signaling indicating the first configuration, the first configuration replacing the second configuration.

According to another aspect of the disclosure, a network node configured to communicate with a wireless device is provided. The network node includes processing circuitry configured to cause transmission of master information block, MIB, where at least a portion of content of the MIB is interpretable using a first configuration different than a second configuration previously stored at the wireless device for interpreting MIB.

According to one or more embodiments of this aspect, the first configuration corresponds to a first table of at least a first CORESET configuration and the second configuration corresponds to a second table of at least a second CORESET configuration different from at least the first CORESET. According to one or more embodiments of this aspect, the first CORESET configuration corresponds to CORESET #0 with a smaller bandwidth than a bandwidth of the second CORESET configuration. According to one or more embodiments of this aspect, the first configuration corresponds to a first version of a wireless communication standard, and where the second configuration corresponds to a second version of the wireless communication standards that is different from the first version.

According to one or more embodiments of this aspect, the MIB associated with the first configuration uses a different scrambling sequence than scrambling sequence associated with the second configuration. According to one or more embodiments of this aspect, the MIB associated with the first configuration uses a different cyclic redundancy check, CRC, than a CRC associated with the second configuration. According to one or more embodiments of this aspect, the MIB associated with the first configuration uses a different primary synchronization signal/primary synchronization signal, PSS/SSS, structure than a PSS/SSS structure associated with the second configuration. According to one or more embodiments of this aspect, the processing circuitry is further configured to cause transmission of signaling indicating the first configuration, the first configuration configured to replace the second configuration.

According to another aspect of the disclosure, a method implemented by a network node that is configured to communicate with a wireless device is provided. Transmission of master information block, MIB, is provided where at least a portion of content of the MIB is interpretable using a first configuration different than a second configuration previously stored at the wireless device for interpreting MIB.

According to one or more embodiments of this aspect, the first configuration corresponds to a first table of at least a first CORESET configuration and the second configuration corresponds to a second table of at least a second CORESET configuration different from at least the first CORESET. According to one or more embodiments of this aspect, the first CORESET configuration corresponds to CORESET #0 with a smaller bandwidth than a bandwidth of the second CORESET configuration. According to one or more embodiments of this aspect, the first configuration corresponds to a first version of a wireless communication standard; and the second configuration corresponds to a second version of the wireless communication standards that is different from the first version. According to one or more embodiments of this aspect, the MIB associated with the first configuration uses a different scrambling sequence than scrambling sequence associated with the second configuration.

According to one or more embodiments of this aspect, the MIB associated with the first configuration uses a different cyclic redundancy check, CRC, than a CRC associated with the second configuration. According to one or more embodiments of this aspect, the MIB associated with the first configuration uses a different primary synchronization signal/primary synchronization signal, PSS/SSS, structure than a PSS/SSS structure associated with the second configuration. According to one or more embodiments of this aspect, transmission of signaling indicating the first configuration is caused where the first configuration configured to replace the second configuration.

### BRIEF DESCRIPTION OF THE DRAWINGS

A more complete understanding of the present embodiments, and the attendant advantages and features thereof, will be more readily understood by reference to the following detailed description when considered in conjunction with the accompanying drawings wherein:

FIG. 1 is a schematic diagram of an exemplary network architecture illustrating a communication system connected via an intermediate network to a host computer according to the principles in the present disclosure;

FIG. 2 is a block diagram of a host computer communicating via a network node with a wireless device over an at least partially wireless connection according to some embodiments of the present disclosure;

FIG. 3 is a flowchart illustrating exemplary methods implemented in a communication system including a host computer, a network node and a wireless device for executing a client application at a wireless device according to some embodiments of the present disclosure;

FIG. 4 is a flowchart illustrating exemplary methods implemented in a communication system including a host computer, a network node and a wireless device for receiving user data at a wireless device according to some embodiments of the present disclosure;

FIG. 5 is a flowchart illustrating exemplary methods implemented in a communication system including a host computer, a network node and a wireless device for receiving user data from the wireless device at a host computer according to some embodiments of the present disclosure;

FIG. 6 is a flowchart illustrating exemplary methods implemented in a communication system including a host computer, a network node and a wireless device for receiving user data at a host computer according to some embodiments of the present disclosure;

FIG. 7 is a flowchart of an exemplary process in a network node according to some embodiments of the present disclosure;

FIG. 8 is a flowchart of another exemplary process in a network node according to some embodiments of the present disclosure;

FIG. 9 is a flowchart of an exemplary process in a wireless device according to some embodiments of the present disclosure;

FIG. 10 is a flowchart of another exemplary process in a wireless device according to some embodiments of the present disclosure;

FIG. 11 is a flowchart of another exemplary process in a wireless device according to some embodiments of the present disclosure; and

FIG. 12 is a flowchart of an exemplary process in a wireless device according to some embodiments of the present disclosure.

### DETAILED DESCRIPTION

Before describing in detail exemplary embodiments, it is noted that the embodiments reside primarily in combinations of apparatus components and processing steps related to using the reserved bit of a MIB as a flag to indicate whether an eMIB is present or as an instruction to interpret at least a portion of content of the MIB in a predefined way, and/or replacing at least a portion of the MIB with content coded in conformance with a second standard that is different than a first standard of the MIB. In other words, in one or more embodiments, the MIB may be interpreted in a predefined way/manner different from the predefined way/manner in which a legacy wireless device would interpret the same MIB. In particular, in some existing wireless communication standards, except for one or more reserved bits, all of the bits on the PBCH have a specific meaning defined in the wireless communication standards, where these one or more reserved bits have not yet been defined, i.e., may lack any associated function and/or functionality defined the existing wireless communication standards. For example, a reserved bit under existing wireless communication standards may refer to a bit that is reserved for future use. In 3GPP Technical Specification (TS) 38.331 V15.4.0, a reserved bit is referred to as a “spare” bit where this spare bit may not have any defined functionality within the MIB other than being spare, as shown below:

-- ASN1START
-- TAG-MIB-START

| | |
|---|---|
| MIB ::= | SEQUENCE { |
| systemFrameNumber | BIT STRING (SIZE (6)), |
| subCarrierSpacingCommon | ENUMERATED {scs15or60, scs30or120}, |
| ssb-SubcarrierOffset | INTEGER (0..15), |
| dmrs-TypeA-Position | ENUMERATED {pos2, pos3}, |
| pdcch-ConfigSIB1 | PDCCH-ConfigSIB1, |
| cellBarred | ENUMERATED {barred, notBarred}, |
| intraFreqReselection | ENUMERATED {allowed, notAllowed}, |
| spare | BIT STRING (SIZE (1)) |

}
-- TAG-MIB-STOP
-- ASN1STOP

In one or more embodiments, the instant disclosure adds functionality to one or more reserved (i.e., “spare”) bits such that the one or more reserved bits in the existing wireless communication standards now have function(s) and/or functionality that is described herein such as the functionality with respect to MIB, i.e., the “spare” bits are no longer spare. Also, for clarity, the one or more bits with new functionality described herein are still referred to as one or more “reserved” bits although these one or more bits correspond to one or more previously reserved bits as these previously reserved bits now have new functionality described herein. Accordingly, components have been represented where appropriate by conventional symbols in the drawings, showing only those specific details that are pertinent to understanding the embodiments so as not to obscure the disclosure with details that will be readily apparent to those of ordinary skill in the art having the benefit of the description herein. Like numbers refer to like elements throughout the description.

As used herein, relational terms, such as “first” and “second,” and the like, may be used solely to distinguish one entity or element from another entity or element without necessarily requiring or implying any physical or logical relationship or order between such entities or elements. The terminology used herein is for the purpose of describing particular embodiments only and is not intended to be limiting of the concepts described herein. As used herein, the singular forms “a”, “an” and “the” are intended to include the plural forms as well, unless the context clearly indicates otherwise. It will be further understood that the terms “comprises,” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

In embodiments described herein, the joining term, “in communication with” and the like, may be used to indicate electrical or data communication, which may be accomplished by physical contact, induction, electromagnetic radiation, radio signaling, infrared signaling or optical signaling, for example. One having ordinary skill in the art will appreciate that multiple components may interoperate and modifications and variations are possible of achieving the electrical and data communication.

In some embodiments described herein, the term “connected,” and the like, may be used herein to indicate a connection, although not necessarily directly, and may include wired and/or wireless connections.

The term “network node” used herein can be any kind of network node comprised in a radio network which may further comprise any of base station (BS), radio base station, base transceiver station (BTS), base station controller (BSC), radio network controller (RNC), g Node B (gNB), evolved Node B (eNB or eNodeB), Node B, multi-standard radio (MSR) radio node such as MSR BS, multi-cell/multicast coordination entity (MCE), relay node, integrated access and backhaul (IAB) node, donor node controlling relay, radio access point (AP), transmission points, transmission nodes, Remote Radio Unit (RRU) Remote Radio Head (RRH), a core network node (e.g., mobile management entity (MME), self-organizing network (SON) node, a coordinating node, positioning node, MDT node, etc.), an external node (e.g., 3rd party node, a node external to the current network), nodes in distributed antenna system (DAS), a spectrum access system (SAS) node, an element management system (EMS), etc. The network node may also comprise test equipment. The term “radio node” used herein may be used to also denote a wireless device (WD) such as a wireless device (WD) or a radio network node.

In some embodiments, the non-limiting terms wireless device (WD) or a user equipment (UE) are used interchangeably. The WD herein can be any type of wireless device capable of communicating with a network node or another WD over radio signals, such as wireless device (WD). The WD may also be a radio communication device, target device, device to device (D2D) WD, machine type WD or WD capable of machine to machine communication (M2M), low-cost and/or low-complexity WD, a sensor equipped with WD, Tablet, mobile terminals, smart phone, laptop embedded equipped (LEE), laptop mounted equipment (LME), USB dongles, Customer Premises Equipment (CPE), an Internet of Things (IoT) device, or a Narrowband IoT (NB-IOT) device etc.

Also, in some embodiments the generic term “radio network node” is used. It can be any kind of a radio network node which may comprise any of base station, radio base station, base transceiver station, base station controller, network controller, RNC, evolved Node B (eNB), Node B, gNB, Multi-cell/multicast Coordination Entity (MCE), (IAB) node, relay node, access point, radio access point, Remote Radio Unit (RRU) Remote Radio Head (RRH).

In one or more embodiments, a reserved bit may refer to bit that is reserved, under one or more communication standards, for future use. In one example, a reserved bit under one or more communications standards is a spare bit and does not have a predefined function associated with, for example, the MIB. In one or more embodiments described herein, the reserved bit is provided with new functionality.

In one or more embodiments, a CORESET may refer to a set of resources in a specific and/or predefined area of a downlink (DL) resource grid.

An indication generally may explicitly and/or implicitly indicate the information it represents and/or indicates. Implicit indication may for example be based on position and/or resource used for transmission. Explicit indication may for example be based on a parametrization with one or more parameters, and/or one or more index or indices, and/or one or more bit patterns representing the information.

Transmitting in downlink may pertain to transmission from the network or network node to the terminal. Transmitting in uplink may pertain to transmission from the terminal to the network or network node. Transmitting in sidelink may pertain to (direct) transmission from one terminal to another. Uplink, downlink and sidelink (e.g., sidelink transmission and reception) may be considered communication directions. In some variants, uplink and downlink may also be used to described wireless communication between network nodes, e.g. for wireless backhaul and/or relay communication and/or (wireless) network communication for example between base stations or similar network nodes, in particular communication terminating at such. It may be considered that backhaul and/or relay communication and/or network communication is implemented as a form of sidelink or uplink communication or similar thereto.

Configuring a terminal or wireless device or node may involve instructing and/or causing the wireless device or node to change its configuration, e.g., at least one setting and/or register entry and/or operational mode. A terminal or wireless device or node may be adapted to configure itself, e.g., according to information or data in a memory of the terminal or wireless device. Configuring a node or terminal or wireless device by another device or node or a network may refer to and/or comprise transmitting information and/or data and/or instructions to the wireless device or node by the other device or node or the network, e.g., data (which may also be and/or comprise configuration data) and/or scheduling data and/or scheduling grants. Configuring a terminal may include sending allocation/configuration data to the terminal indicating how to interpret the MIB. A terminal may be configured with and/or for scheduling data and/or to use, e.g., for transmission, scheduled and/or allocated uplink resources, and/or, e.g., for reception, scheduled and/or allocated downlink resources. Uplink resources and/or downlink resources may be scheduled and/or provided with allocation or configuration data.

Note that although terminology from one particular wireless system, such as, for example, 3GPP LTE and/or New Radio (NR), may be used in this disclosure, this should not be seen as limiting the scope of the disclosure to only the aforementioned system. Other wireless systems, including without limitation Wide Band Code Division Multiple Access (WCDMA), Worldwide Interoperability for Microwave Access (WiMax), Ultra Mobile Broadband (UMB) and Global System for Mobile Communications (GSM), may also benefit from exploiting the ideas covered within this disclosure.

Note further, that functions described herein as being performed by a wireless device or a network node may be distributed over a plurality of wireless devices and/or network nodes. In other words, it is contemplated that the functions of the network node and wireless device described herein are not limited to performance by a single physical device and, in fact, can be distributed among several physical devices.

Unless otherwise defined, all terms (including technical and scientific terms) used herein have the same meaning as commonly understood by one of ordinary skill in the art to which this disclosure belongs. It will be further understood that terms used herein should be interpreted as having a meaning that is consistent with their meaning in the context of this specification and the relevant art and will not be interpreted in an idealized or overly formal sense unless expressly so defined herein.

Using prior systems and methods, it is difficult to introduce more signaling options in the MIB, for example the possibility to support CORESET #0 sizes of less than 24 RBs. There is only a single reserved bit, i.e., spare bit, in the current standard for MIBs for future use while there may be multiple extensions needed. Accordingly, embodiments provide for using the reserved bit of a MIB as a flag to indicate whether an eMIB is present or as an instruction to interpret at least a portion of content of the MIB in a predefined way, and/or replacing at least a portion of the MIB with content coded in conformance with a second communication standard that is different than a first communication standard of the MIB. Thus, the reserved bit may function as a flag that indicates whether an eMIB is present or not. The eMIB may be transmitted in a manner such that legacy WDs will not detect it and it will not interfere with the legacy device's functioning.

Thus, in various embodiments, new features requiring additional system information can be supported in a backwards-compatible manner. For example, a CORESET #0 may be configured that is of a different size than is possible in existing wireless communication standards.

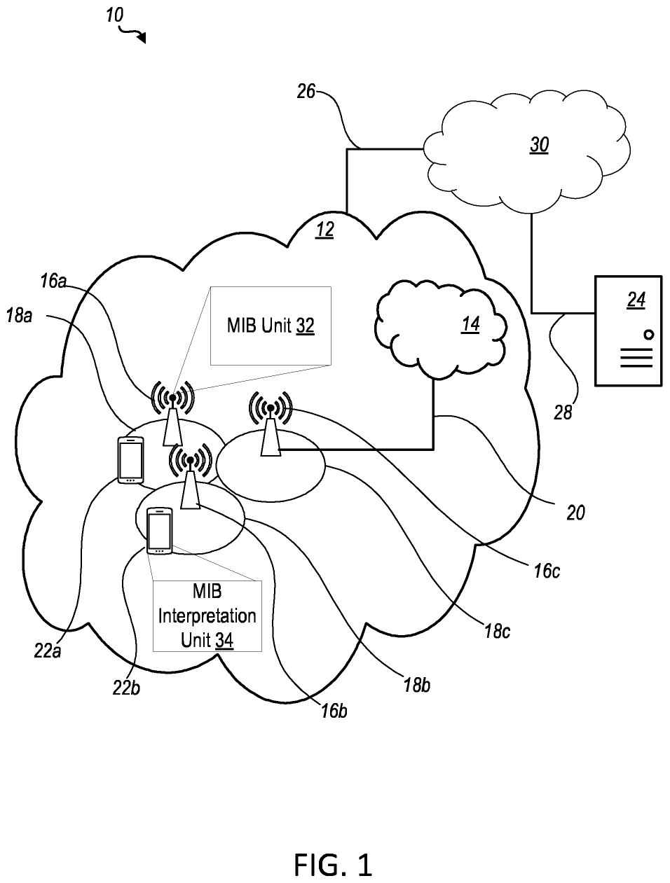

Referring now to the drawing figures, in which like elements are referred to by like reference numerals, there is shown in FIG. 1 a schematic diagram of a communication system 10, according to an embodiment, such as a 3GPP-type cellular network that may support standards such as LTE and/or NR (5G), which comprises an access network 12, such as a radio access network, and a core network 14. The access network 12 comprises a plurality of network nodes 16a, 16b, 16c (referred to collectively as network nodes 16), such as NBs, eNBs, gNBs or other types of wireless access points, each defining a corresponding coverage area 18a, 18b, 18c (referred to collectively as coverage areas 18). Each network node 16a, 16b, 16c is connectable to the core network 14 over a wired or wireless connection 20. A first wireless device (WD) 22a located in coverage area 18a is configured to wirelessly connect to, or be paged by, the corresponding network node 16a. A second WD 22b in coverage area 18b is wirelessly connectable to the corresponding network node 16b. While a plurality of WDs 22a, 22b (collectively referred to as wireless devices 22) are illustrated in this example, the disclosed embodiments are equally applicable to a situation where a sole WD is in the coverage area or where a sole WD is connecting to the corresponding network node 16. Note that although only two WDs 22 and three network nodes 16 are shown for convenience, the communication system may include many more WDs 22 and network nodes 16.

Also, it is contemplated that a WD 22 can be in simultaneous communication and/or configured to separately communicate with more than one network node 16 and more than one type of network node 16. For example, a WD 22 can have dual connectivity with a network node 16 that supports LTE and the same or a different network node 16 that supports NR. As an example, WD 22 can be in communication with an eNB for LTE/E-UTRAN and a gNB for NR/NG-RAN.

The communication system 10 may itself be connected to a host computer 24, which may be embodied in the hardware and/or software of a standalone server, a cloud-implemented server, a distributed server or as processing resources in a server farm. The host computer 24 may be under the ownership or control of a service provider, or may be operated by the service provider or on behalf of the service provider. The connections 26, 28 between the communication system 10 and the host computer 24 may extend directly from the core network 14 to the host computer 24 or may extend via an optional intermediate network 30. The intermediate network 30 may be one of, or a combination of more than one of, a public, private or hosted network. The intermediate network 30, if any, may be a backbone network or the Internet. In some embodiments, the intermediate network 30 may comprise two or more sub-networks (not shown).

The communication system of FIG. 1 as a whole enables connectivity between one of the connected WDs 22a, 22b and the host computer 24. The connectivity may be described as an over-the-top (OTT) connection. The host computer 24 and the connected WDs 22a, 22b are configured to communicate data and/or signaling via the OTT connection, using the access network 12, the core network 14, any intermediate network 30 and possible further infrastructure (not shown) as intermediaries. The OTT connection may be transparent in the sense that at least some of the participating communication devices through which the OTT connection passes are unaware of routing of uplink and downlink communications. For example, a network node 16 may not or need not be informed about the past routing of an incoming downlink communication with data originating from a host computer 24 to be forwarded (e.g., handed over) to a connected WD 22a. Similarly, the network node 16 need not be aware of the future routing of an outgoing uplink communication originating from the WD 22a towards the host computer 24.

A network node 16 is configured to include a MIB unit 32 which is configured to perform one or more network node 16 functions described herein such as with respect to interpretation of a MIB. As used herein, “interpreting” MIB may refer to interpreting a received MIB in a different manner than defined in existing standards such as different from the way/manner in which a legacy wireless device may interpret the same MIB. For example, WD 22 receiving a MIB may be able to interpret the MIB in a predefined manner according to existing wireless communication standards such as 3GPP TS 38.331 V15.4.0; however, the same MIB may be interpreted differently, i.e., reinterpreted, as described herein, where the interpretation of a MIB may be based on a flag and/or value associated with one or more reserved bit(s) or may be based on an additional MIB and/or may be based on a different definition (from existing wireless communication standards) that is assigned to one or more fields of the MIB and/or based on a new table of configurations.

In one or more embodiments, MIB unit 32 is configured to use a reserved bit of a MIB transmitted to the WD as an indication of at least one of the presence of an eMIB (extension MIB) or an instruction to reinterpret at least a portion of content of the MIB and/or replace an interpretation (i.e., use a different interpretation) of at least a portion of the MIB with content coded in conformance with a second communication standard that is different than content coded in conformance with a first communication standard of the MIB. In one or more embodiments, eMIB generally refers to additional MIB data/information where the size of the eMIB may be one of equal to, less than or greater than the size of the MIB. A wireless device 22 is configured to include a MIB interpretation unit 34 which is configured to use a reserved bit of a received MIB as an indication of at least one of the presence of an eMIB and an instruction to reinterpret at least a portion of content of the MIB and/or decode at least a portion of the MIB content in conformance with a second communication standard that is different than a first communication standard of at least a portion of the MIB content.

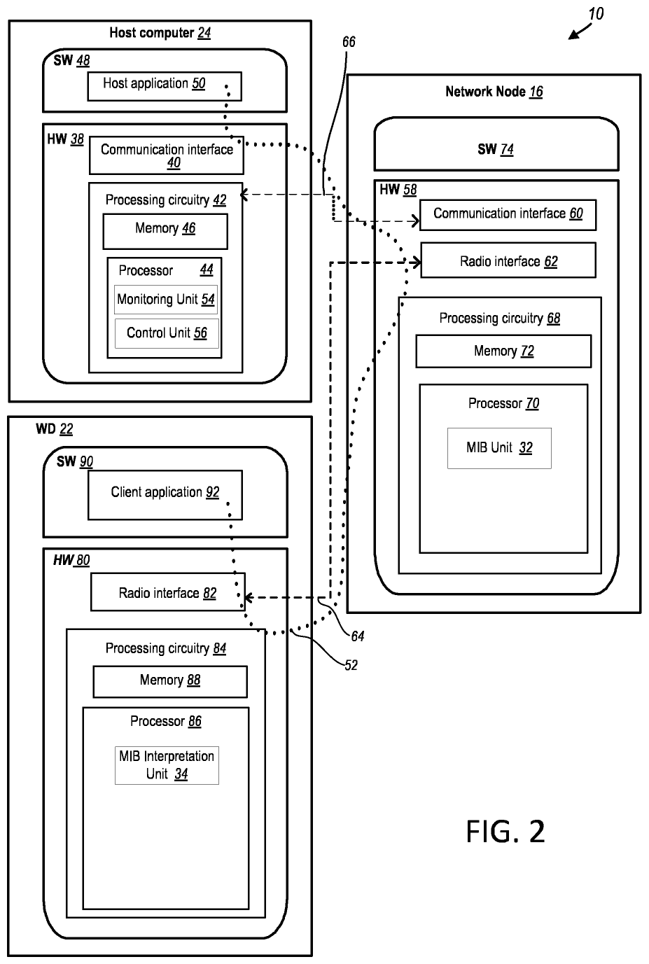

Example implementations, in accordance with an embodiment, of the WD 22, network node 16 and host computer 24 discussed in the preceding paragraphs will now be described with reference to FIG. 2. In a communication system 10, a host computer 24 comprises hardware (HW) 38 including a communication interface 40 configured to set up and maintain a wired or wireless connection with an interface of a different communication device of the communication system 10. The host computer 24 further comprises processing circuitry 42, which may have storage and/or processing capabilities. The processing circuitry 42 may include a processor 44 and memory 46. In particular, in addition to or instead of a processor, such as a central processing unit, and memory, the processing circuitry 42 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 44 may be configured to access (e.g., write to and/or read from) memory 46, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Processing circuitry 42 may be configured to control any of the methods and/or processes described herein and/or to cause such methods, and/or processes to be performed, e.g., by host computer 24. Processor 44 corresponds to one or more processors 44 for performing host computer 24 functions described herein. The host computer 24 includes memory 46 that is configured to store data, programmatic software code and/or other information described herein. In some embodiments, the software 48 and/or the host application 50 may include instructions that, when executed by the processor 44 and/or processing circuitry 42, causes the processor 44 and/or processing circuitry 42 to perform the processes described herein with respect to host computer 24. The instructions may be software associated with the host computer 24.

The software 48 may be executable by the processing circuitry 42. The software 48 includes a host application 50. The host application 50 may be operable to provide a service to a remote user, such as a WD 22 connecting via an OTT connection 52 terminating at the WD 22 and the host computer 24. In providing the service to the remote user, the host application 50 may provide user data which is transmitted using the OTT connection 52. The “user data” may be data and information described herein as implementing the described functionality. In one embodiment, the host computer 24 may be configured for providing control and functionality to a service provider and may be operated by the service provider or on behalf of the service provider. The processing circuitry 42 of the host computer 24 may enable the host computer 24 to observe, monitor, control, transmit to and/or receive from the network node 16 and or the wireless device 22. The processing circuitry 42 of the host computer 24 may include a monitoring unit 54 configured to enable the service provider to monitor the network node 16 and/or the wireless device 22. The processing circuitry 42 of the host computer 24 may also include a control unit 56 configured to enable the service provider to control the network node 16 and/or the wireless device 22.

The communication system 10 further includes a network node 16 provided in a communication system 10 and including hardware 58 enabling it to communicate with the host computer 24 and with the WD 22. The hardware 58 may include a communication interface 60 for setting up and maintaining a wired or wireless connection with an interface of a different communication device of the communication system 10, as well as a radio interface 62 for setting up and maintaining at least a wireless connection 64 with a WD 22 located in a coverage area 18 served by the network node 16. The radio interface 62 may be formed as or may include, for example, one or more RF transmitters, one or more RF receivers, and/or one or more RF transceivers. The communication interface 60 may be configured to facilitate a connection 66 to the host computer 24. The connection 66 may be direct or it may pass through a core network 14 of the communication system 10 and/or through one or more intermediate networks 30 outside the communication system 10.

In the embodiment shown, the hardware 58 of the network node 16 further includes processing circuitry 68. The processing circuitry 68 may include a processor 70 and a memory 72. In particular, in addition to or instead of a processor, such as a central processing unit, and memory, the processing circuitry 68 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 70 may be configured to access (e.g., write to and/or read from) the memory 72, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the network node 16 further has software 74 stored internally in, for example, memory 72, or stored in external memory (e.g., database, storage array, network storage device, etc.) accessible by the network node 16 via an external connection. The software 74 may be executable by the processing circuitry 68. The processing circuitry 68 may be configured to control any of the methods and/or processes described herein and/or to cause such methods, and/or processes to be performed, e.g., by network node 16. Processor 70 corresponds to one or more processors 70 for performing network node 16 functions described herein. The memory 72 is configured to store data, programmatic software code and/or other information described herein. In some embodiments, the software 74 may include instructions that, when executed by the processor 70 and/or processing circuitry 68, causes the processor 70 and/or processing circuitry 68 to perform the processes described herein with respect to network node 16. For example, processing circuitry 68 of the network node 16 may include MIB unit 32 configured to use a reserved bit of a MIB transmitted to the WD as an indication of at least one of the presence of an eMIB and/or an instruction to interpret at least a portion of content of the MIB in a predefined way and/or an instruction to replace at least a portion of the MIB with content coded in conformance with a second communication standard that is different than content coded in conformance with a first communication standard of the MIB. The communication system 10 further includes the WD 22 already referred to.

The WD 22 may have hardware 80 that may include a radio interface 82 configured to set up and maintain a wireless connection 64 with a network node 16 serving a coverage area 18 in which the WD 22 is currently located. The radio interface 82 may be formed as or may include, for example, one or more RF transmitters, one or more RF receivers, and/or one or more RF transceivers.

The hardware 80 of the WD 22 further includes processing circuitry 84. The processing circuitry 84 may include a processor 86 and memory 88. In particular, in addition to or instead of a processor, such as a central processing unit, and memory, the processing circuitry 84 may comprise integrated circuitry for processing and/or control, e.g., one or more processors and/or processor cores and/or FPGAs (Field Programmable Gate Array) and/or ASICs (Application Specific Integrated Circuitry) adapted to execute instructions. The processor 86 may be configured to access (e.g., write to and/or read from) memory 88, which may comprise any kind of volatile and/or nonvolatile memory, e.g., cache and/or buffer memory and/or RAM (Random Access Memory) and/or ROM (Read-Only Memory) and/or optical memory and/or EPROM (Erasable Programmable Read-Only Memory).

Thus, the WD 22 may further comprise software 90, which is stored in, for example, memory 88 at the WD 22, or stored in external memory (e.g., database, storage array, network storage device, etc.) accessible by the WD 22. The software 90 may be executable by the processing circuitry 84. The software 90 may include a client application 92. The client application 92 may be operable to provide a service to a human or non-human user via the WD 22, with the support of the host computer 24. In the host computer 24, an executing host application 50 may communicate with the executing client application 92 via the OTT connection 52 terminating at the WD 22 and the host computer 24. In providing the service to the user, the client application 92 may receive request data from the host application 50 and provide user data in response to the request data. The OTT connection 52 may transfer both the request data and the user data. The client application 92 may interact with the user to generate the user data that it provides.

The processing circuitry 84 may be configured to control any of the methods and/or processes described herein and/or to cause such methods, and/or processes to be performed, e.g., by WD 22. The processor 86 corresponds to one or more processors 86 for performing WD 22 functions described herein. The WD 22 includes memory 88 that is configured to store data, programmatic software code and/or other information described herein. In some embodiments, the software 90 and/or the client application 92 may include instructions that, when executed by the processor 86 and/or processing circuitry 84, causes the processor 86 and/or processing circuitry 84 to perform the processes described herein with respect to WD 22. For example, the processing circuitry 84 of the wireless device 22 may include a MIB interpretation unit 34 configured to use a reserved bit of a received MIB as an indication of at least one of the presence of an eMIB and/or an instruction to reinterpret at least a portion of content of the MIB in a predefined way and/or decode at least a portion of the MIB content in conformance with a second communication standard that is different than a first communication standard of at least a portion of the MIB content.

In some embodiments, the inner workings of the network node 16, WD 22, and host computer 24 may be as shown in FIG. 2 and independently, the surrounding network topology may be that of FIG. 1.

In FIG. 2, the OTT connection 52 has been drawn abstractly to illustrate the communication between the host computer 24 and the wireless device 22 via the network node 16, without explicit reference to any intermediary devices and the precise routing of messages via these devices. Network infrastructure may determine the routing, which it may be configured to hide from the WD 22 or from the service provider operating the host computer 24, or both. While the OTT connection 52 is active, the network infrastructure may further take decisions by which it dynamically changes the routing (e.g., on the basis of load balancing consideration or reconfiguration of the network).

The wireless connection 64 between the WD 22 and the network node 16 is in accordance with the teachings of the embodiments described throughout this disclosure. One or more of the various embodiments improve the performance of OTT services provided to the WD 22 using the OTT connection 52, in which the wireless connection 64 may form the last segment. More precisely, the teachings of some of these embodiments may improve the data rate, latency, and/or power consumption and thereby provide benefits such as reduced user waiting time, relaxed restriction on file size, better responsiveness, extended battery lifetime, etc.

In some embodiments, a measurement procedure may be provided for the purpose of monitoring data rate, latency and other factors on which the one or more embodiments improve. There may further be an optional network functionality for reconfiguring the OTT connection 52 between the host computer 24 and WD 22, in response to variations in the measurement results. The measurement procedure and/or the network functionality for reconfiguring the OTT connection 52 may be implemented in the software 48 of the host computer 24 or in the software 90 of the WD 22, or both. In embodiments, sensors (not shown) may be deployed in or in association with communication devices through which the OTT connection 52 passes; the sensors may participate in the measurement procedure by supplying values of the monitored quantities exemplified above, or supplying values of other physical quantities from which software 48, 90 may compute or estimate the monitored quantities. The reconfiguring of the OTT connection 52 may include message format, retransmission settings, preferred routing etc.; the reconfiguring need not affect the network node 16, and it may be unknown or imperceptible to the network node 16. Some such procedures and functionalities may be known and practiced in the art. In certain embodiments, measurements may involve proprietary WD signaling facilitating the host computer's 24 measurements of throughput, propagation times, latency and the like. In some embodiments, the measurements may be implemented in that the software 48, 90 causes messages to be transmitted, in particular empty or ‘dummy’ messages, using the OTT connection 52 while it monitors propagation times, errors etc.

Thus, in some embodiments, the host computer 24 includes processing circuitry 42 configured to provide user data and a communication interface 40 that is configured to forward the user data to a cellular network for transmission to the WD 22. In some embodiments, the cellular network also includes the network node 16 with a radio interface 62. In some embodiments, the network node 16 is configured to, and/or the network node's 16 processing circuitry 68 is configured to perform the functions and/or methods described herein for preparing/initiating/maintaining/supporting/ending a transmission to the WD 22, and/or preparing/terminating/maintaining/supporting/ending in receipt of a transmission from the WD 22.

In some embodiments, the host computer 24 includes processing circuitry 42 and a communication interface 40 that is configured to a communication interface 40 configured to receive user data originating from a transmission from a WD 22 to a network node 16. In some embodiments, the WD 22 is configured to, and/or comprises a radio interface 82 and/or processing circuitry 84 configured to perform the functions and/or methods described herein for preparing/initiating/maintaining/supporting/ending a transmission to the network node 16, and/or preparing/terminating/maintaining/supporting/ending in receipt of a transmission from the network node 16.

Although FIGS. 1 and 2 show various “units” such as MIB unit 32, and MIB interpretation unit 34 as being within a respective processor, it is contemplated that these units may be implemented such that a portion of the unit is stored in a corresponding memory within the processing circuitry. In other words, the units may be implemented in hardware or in a combination of hardware and software within the processing circuitry.

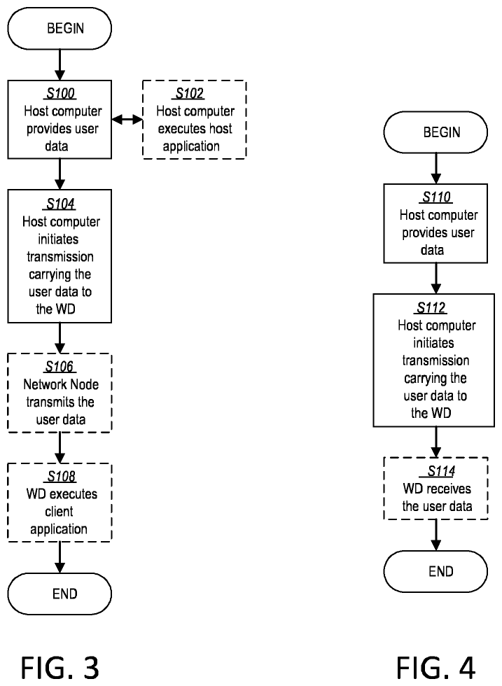

FIG. 3 is a flowchart illustrating an exemplary method implemented in a communication system, such as, for example, the communication system of FIGS. 1 and 2, in accordance with one embodiment. The communication system may include a host computer 24, a network node 16 and a WD 22, which may be those described with reference to FIG. 2. In a first step of the method, the host computer 24 provides user data (Block S100). In an optional substep of the first step, the host computer 24 provides the user data by executing a host application, such as, for example, the host application 50 (Block S102). In a second step, the host computer 24 initiates a transmission carrying the user data to the WD 22 (Block S104). In an optional third step, the network node 16 transmits to the WD 22 the user data which was carried in the transmission that the host computer 24 initiated, in accordance with the teachings of the embodiments described throughout this disclosure (Block S106). In an optional fourth step, the WD 22 executes a client application, such as, for example, the client application 92, associated with the host application 50 executed by the host computer 24 (Block S108).

FIG. 4 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In a first step of the method, the host computer 24 provides user data (Block S110). In an optional substep (not shown) the host computer 24 provides the user data by executing a host application, such as, for example, the host application 50. In a second step, the host computer 24 initiates a transmission carrying the user data to the WD 22 (Block S112). The transmission may pass via the network node 16, in accordance with the teachings of the embodiments described throughout this disclosure. In an optional third step, the WD 22 receives the user data carried in the transmission (Block S114).

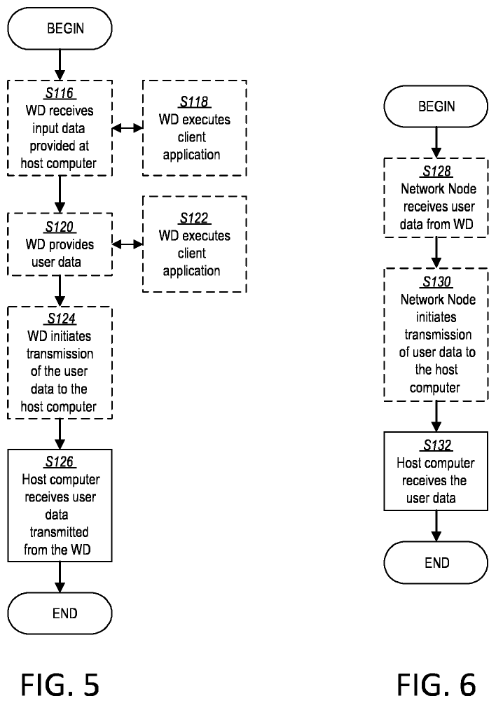

FIG. 5 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, the WD 22 receives input data provided by the host computer 24 (Block S116). In an optional substep of the first step, the WD 22 executes the client application 92, which provides the user data in reaction to the received input data provided by the host computer 24 (Block S118). Additionally or alternatively, in an optional second step, the WD 22 provides user data (Block S120). In an optional substep of the second step, the WD provides the user data by executing a client application, such as, for example, client application 92 (Block S122). In providing the user data, the executed client application 92 may further consider user input received from the user. Regardless of the specific manner in which the user data was provided, the WD 22 may initiate, in an optional third substep, transmission of the user data to the host computer 24 (Block S124). In a fourth step of the method, the host computer 24 receives the user data transmitted from the WD 22, in accordance with the teachings of the embodiments described throughout this disclosure (Block S126).

FIG. 6 is a flowchart illustrating an exemplary method implemented in a communication system, such as, for example, the communication system of FIG. 1, in accordance with one embodiment. The communication system may include a host computer 24, a network node 16 and a WD 22, which may be those described with reference to FIGS. 1 and 2. In an optional first step of the method, in accordance with the teachings of the embodiments described throughout this disclosure, the network node 16 receives user data from the WD 22 (Block S128). In an optional second step, the network node 16 initiates transmission of the received user data to the host computer 24 (Block S130). In a third step, the host computer 24 receives the user data carried in the transmission initiated by the network node 16 (Block S132).

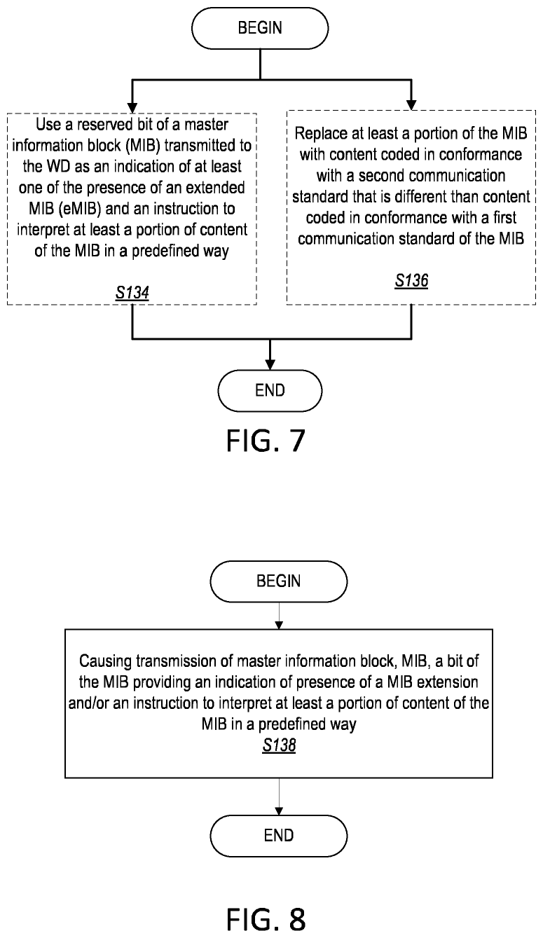

FIG. 7 is a flowchart of an exemplary process in a network node 16. One or more Blocks and/or functions performed by network node 16 may be performed by one or more elements of network node 16 such as by MIB unit 32 in processing circuitry 68, processor 70, communication interface 60, radio interface 62, etc. In one or more embodiments, network node 16 such as via one or more of processing circuitry 68, processor 70, radio interface 62 and communication interface 60 is configured to perform at least one of: (A) using (Block S134) a reserved bit of a master information block (MIB) transmitted to the WD as an indication of at least one of the presence of an extended MIB (eMIB) and an instruction to interpret at least a portion of content of the MIB in a predefined way; and (B) replacing (Block S136) at least a portion of the MIB with content coded in conformance with a second communication standard that is different than content coded in conformance with a first communication standard of the MIB.

In one or more embodiments, the network node 16 such as via one or more of processing circuitry 68, processor 70, radio interface 62 and communication interface 60 is configured to transmit the eMIB such that the eMIB is not detectable by a legacy WD 22. In one or more embodiments, the network node 16 such as via one or more of processing circuitry 68, processor 70, radio interface 62 and communication interface 60 is configured to use at least one of a different physical broadcast channel (PBCH) scrambling sequence for the eMIB than was used for the MIB and a different PBCH cyclic redundancy check (CRC) for the eMIB than was used for the current MIB such that the eMIB is not detectable and/or decodable by legacy WDs 22. In one or more embodiments, the network node 16 such as via one or more of processing circuitry 68, processor 70, radio interface 62 and communication interface 60 is configured to, if a synchronization signal block (SSB) structure is reused, use a different at least one of a primary synchronization signal (PSS) and a secondary synchronization signal (SSS) with values not representing a valid combination according to a specification of the MIB.

In one or more embodiments, the network node 16 such as via one or more of processing circuitry 68, processor 70, radio interface 62 and communication interface 60 is configured to define a transmission timing of the eMIB in relation to the MIB. In one or more embodiments, the network node 16 such as via one or more of processing circuitry 68, processor 70, radio interface 62 and communication interface 60 is configured to use a next possible MIB occasion for the eMIB relative to the MIB in which the eMIB was flagged such as by the reserve bit(s). In one or more embodiments, the network node 16 such as via one or more of processing circuitry 68, processor 70, radio interface 62 and communication interface 60 is configured to repurpose resource elements occupied by at least one of a PSS or an SSS. For example, PSS/SSS may not be needed for the eMIB transmission such that the network node 16 may use resources elements that would otherwise be occupied by PSS/SSS for other purposes such as to carry other data, information and/or signaling, etc. In one or more embodiments, the network node 16 such as via one or more of processing circuitry 68, processor 70, radio interface 62 and communication interface 60 is configured to transmit the eMIB using a smaller number of orthogonal frequency division multiplexing (OFDM) symbols than used for the SSB.

FIG. 8 is a flowchart of another exemplary process in a network node 16 according to one or more embodiments of the disclosure. One or more Blocks and/or functions performed by network node 16 may be performed by one or more elements of network node 16 such as by MIB unit 32 in processing circuitry 68, processor 70, communication interface 60, radio interface 62, etc. In one or more embodiments, network node 16 such as via one or more of processing circuitry 68, processor 70, radio interface 62 and communication interface 60 is configured to cause (Block S138) transmission of master information block, MIB, a bit of the MIB providing an indication of presence of a MIB extension and/or an instruction to interpret at least a portion of content of the MIB in a predefined way, as described herein.

According to one or more embodiments, the bit is a reserved bit in the MIB. According to one or more embodiments, the bit of the MIB provides an indication of presence of the MIB extension, and the processing circuitry 68 is further configured to cause transmission of the MIB extension. According to one or more embodiments, the processing circuitry 68 is configured to cause transmission of the MIB extension in response to the bit of the MIB having a predefined value.

According to one or more embodiments, the MIB extension is an additional MIB. According to one or more embodiments, the MIB extension is transmitted via a physical broadcast channel, PBCH. According to one or more embodiments, the processing circuitry 68 is configured to cause transmission of a physical downlink control channel, a configuration of the physical downlink control channel being indicated by the MIB extension. According to one or more embodiments, the MIB defines a CORESET #0, and the MIB extension defines a different CORESET #0 that has a smaller bandwidth than a bandwidth of the CORESET #0 defined by the MIB.

According to one or more embodiments, a size of the MIB extension is less than a size of the MIB. According to one or more embodiments, a different scrambling sequence is used for the MIB extension than for the MIB. According to one or more embodiments, a different CRC is used for the MIB extension than for the MIB. According to one or more embodiments, the interpreting of at least the portion of content of the MIB in the predefined way includes at least one of: interpreting at least the portion of content of the MIB in a first predefined way in response to the bit of the MIB having a first value, and interpreting at least the portion of the content of the MIB in a second predefined way in response to the bit of the MIB having a second value.

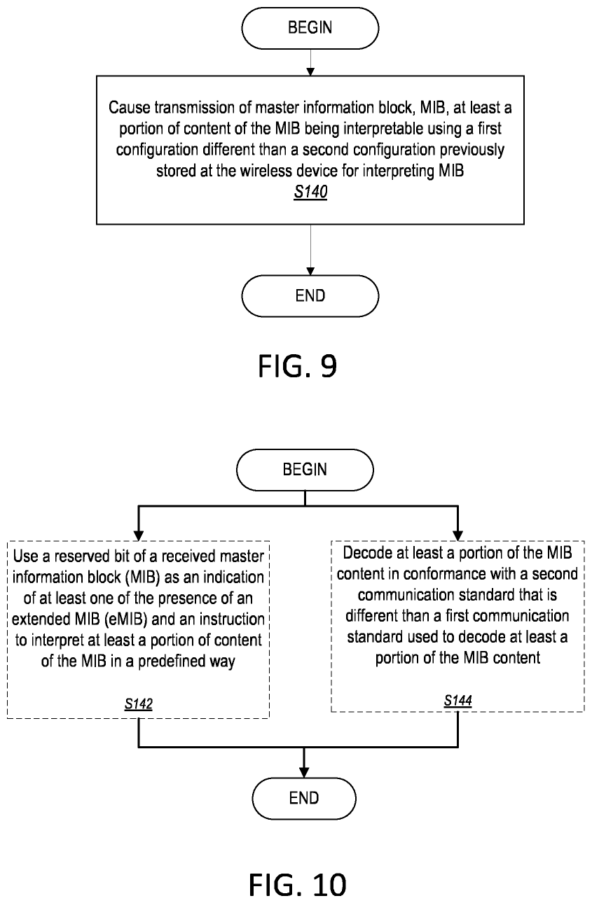

FIG. 9 is a flowchart of another exemplary process in a network node 16 according to one or more embodiments of the disclosure. One or more Blocks and/or functions performed by network node 16 may be performed by one or more elements of network node 16 such as by MIB unit 32 in processing circuitry 68, processor 70, communication interface 60, radio interface 62, etc. In one or more embodiments, network node 16 such as via one or more of processing circuitry 68, processor 70, radio interface 62 and communication interface 60 is configured to cause (Block S140) transmission of master information block, MIB, where at least a portion of content of the MIB is interpretable using a first configuration different than a second configuration previously stored at the wireless device 22 for interpreting MIB, as described herein.

According to one or more embodiments, the first configuration corresponds to a first table of at least a first CORESET configuration and the second configuration corresponds to a second table of at least a second CORESET configuration different from at least the first CORESET. According to one or more embodiments, the first CORESET configuration corresponds to CORESET #0 with a smaller bandwidth than a bandwidth of the second CORESET configuration. According to one or more embodiments, the first configuration corresponds to a first version of a wireless communication standard; and the second configuration corresponds to a second version of the wireless communication standards that is different from the first version.

According to one or more embodiments, the MIB associated with the first configuration uses a different scrambling sequence than scrambling sequence associated with the second configuration. According to one or more embodiments, the MIB associated with the first configuration uses a different cyclic redundancy check, CRC, than a CRC associated with the second configuration. According to one or more embodiments, the MIB associated with the first configuration uses a different primary synchronization signal/primary synchronization signal, PSS/SSS, structure than a PSS/SSS structure associated with the second configuration. According to one or more embodiments, the processing circuitry is further configured to cause transmission of signaling indicating the first configuration, the first configuration configured to replace the second configuration.

FIG. 10 is a flowchart of an exemplary process in a wireless device 22 according to some embodiments of the present disclosure. One or more Blocks and/or functions performed by wireless device 22 may be performed by one or more elements of wireless device 22 such as by MIB interpretation unit 34 in processing circuitry 84, processor 86, radio interface 82, etc. In one or more embodiments, wireless device 22 such as via one or more of processing circuitry 84, processor 86 and radio interface 82 is configured to perform at least one of (A) using (Block S142) a reserved bit of a received master information block (MIB) as an indication of at least one of the presence of an extended MIB (eMIB) and an instruction to interpret at least a portion of content of the MIB in a predefined way; and (B) decoding (Block S144) at least a portion of the MIB content in conformance with a second communication standard that is different than a first communication standard used to decode at least a portion of the MIB content, as described herein.

In one or more embodiments of the WD 22, the WD 22 is configured to, and/or comprises a radio interface and/or processing circuitry configured to receive and decode the eMIB. In one or more embodiments of the WD 22, the WD 22 is configured to, and/or comprises a radio interface and/or processing circuitry configured to use at least one of a different physical broadcast channel (PBCH) scrambling sequence than the MIB and a different PBCH cyclic redundancy check (CRC) than the MIB. In one or more embodiments of the WD 22, the WD 22 is configured to, and/or comprises a radio interface and/or processing circuitry configured to, if a synchronization signal block (SSB) structure is reused, use a different at least one of a primary synchronization signal (PSS) and a secondary synchronization signal (SSS) with values not representing a valid combination according to a specification of the MIB.

In one or more embodiments of the WD 22, the WD 22 is configured to, and/or comprises a radio interface and/or processing circuitry configured to decode a reception timing of the eMIB in relation to the MIB. In one or more embodiments of the WD 22, the WD 22 is configured to, and/or comprises a radio interface and/or processing circuitry configured to interpret a subsequently received MIB as the eMIB, i.e., interpret a MIB received after the MIB flagging as the eMIB which allows the WD 22 to interpret the MIB along with the additional MIB (i.e., eMIB). In one or more embodiments of the WD 22, the WD 22 is configured to, and/or comprises a radio interface and/or processing circuitry configured to interpret resource elements occupied by at least one of a PSS or an SSS. In one or more embodiments of the WD 22, the WD 22 is configured to, and/or comprises a radio interface and/or processing circuitry configured to receive the eMIB using a smaller number of orthogonal frequency division multiplexing (OFDM) symbols than used for the SSB.

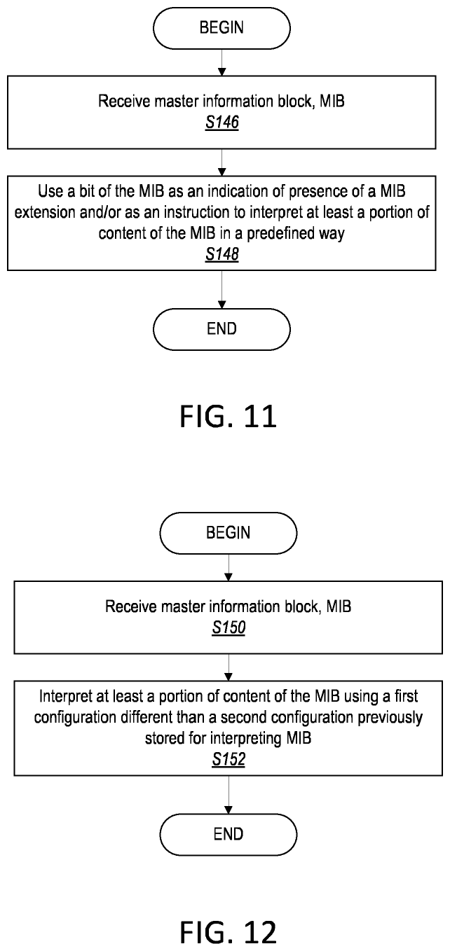

FIG. 11 is a flowchart of an exemplary process in a wireless device 22 according to some embodiments of the present disclosure. One or more Blocks and/or functions performed by wireless device 22 may be performed by one or more elements of wireless device 22 such as by MIB interpretation unit 34 in processing circuitry 84, processor 86, radio interface 82, etc. In one or more embodiments, wireless device 22 such as via one or more of processing circuitry 84, processor 86 and radio interface 82 is configured to receive (Block S146) master information block, MIB, as described herein. In one or more embodiments, wireless device 22 such as via one or more of processing circuitry 84, processor 86 and radio interface 82 is configured to use (Block S148) a bit of the MIB as an indication of presence of a MIB extension and/or as an instruction to interpret at least a portion of content of the MIB in a predefined way, as described herein.

According to one or more embodiments, the bit is a reserved bit in the MIB. According to one or more embodiments, the processing circuitry 84 is configured to use the bit of the MIB as an indication of presence of the MIB extension, and receive the MIB extension. According to one or more embodiments, the processing circuitry 84 is configured to receive the MIB extension in response to the bit of the MIB having a predefined value.

According to one or more embodiments, the MIB extension is an additional MIB. According to one or more embodiments, the MIB extension is received via a physical broadcast channel, PBCH. According to one or more embodiments, the processing circuitry 84 is configured to determine a configuration for physical downlink control channel reception based at least on the MIB extension.

According to one or more embodiments, the MIB defines a CORESET #0, and the MIB extension defines a different CORESET #0 that has a smaller bandwidth than a bandwidth of the CORESET #0 defined by the MIB. According to one or more embodiments, a size of the MIB extension is less than a size of the MIB. According to one or more embodiments, a different scrambling sequence is used for the MIB extension than for the MIB. According to one or more embodiments, a different CRC is used for the MIB extension than for the MIB. According to one or more embodiments, the interpreting of at least the portion of content of the MIB in the predefined way includes at least one of: interpreting at least the portion of content of the MIB in a first predefined way in response to the bit of the MIB having a first value, and interpreting at least the portion of the content of the MIB in a second predefined way in response to the bit of the MIB having a second value.

FIG. 12 is a flowchart of an exemplary process in a wireless device 22 according to some embodiments of the present disclosure. One or more Blocks and/or functions performed by wireless device 22 may be performed by one or more elements of wireless device 22 such as by MIB interpretation unit 34 in processing circuitry 84, processor 86, radio interface 82, etc. In one or more embodiments, wireless device 22 such as via one or more of processing circuitry 84, processor 86 and radio interface 82 is configured to receive (Block S150) master information block, MIB. In one or more embodiments, wireless device 22 such as via one or more of processing circuitry 84, processor 86 and radio interface 82 is configured to interpret (Block S152) at least a portion of content of the MIB using a first configuration different than a second configuration previously stored for interpreting MIB.

According to one or more embodiments, the first configuration corresponds to a first table of at least a first CORESET configuration and the second configuration corresponds to a second table of at least a second CORESET configuration different from at least the first CORESET. According to one or more embodiments, the first CORESET configuration corresponds to CORESET #0 with a smaller bandwidth than a bandwidth of the second CORESET configuration. According to one or more embodiments, the first configuration corresponds to a first version of a wireless communication standard where the second configuration corresponds to a second version of the wireless communication standards that is different from the first version.

According to one or more embodiments, the MIB associated with the first configuration uses a different scrambling sequence than scrambling sequence associated with the second configuration. According to one or more embodiments, the MIB associated with the first configuration uses a different cyclic redundancy check, CRC, than a CRC associated with the second configuration According to one or more embodiments, the MIB associated with the first configuration uses a different primary synchronization signal/primary synchronization signal, PSS/SSS, structure than a PSS/SSS structure associated with the second configuration. According to one or more embodiments, the processing circuitry is further configured to receive signaling indicating the first configuration, the first configuration replacing the second configuration.

Having described the general process flow of arrangements of the disclosure and having provided examples of hardware and software arrangements for implementing the processes and functions of the disclosure, the sections below provide details and examples of arrangements for extending, repurposing and reinterpreting MIB content.

In some embodiments, information may be added to SIBs in a backwards-compatible manner. SIBs are scheduled in a similar way as is performed in data transmission according to existing wireless communication protocols. In some embodiments, a PDCCH may indicate to the WD 22 that the Physical Downlink Shared Channel (PDSCH) is to be received and the PDSCH contains the SIB, or SIBs. Adding information to SIBs in a backwards-compatible manner may be accomplished as the payload size and structure may be indicated on the PDCCH and is not mandated by known communication standards, e.g., known 3GPP communication standards.

Some embodiments provide for the reserved bit in a MIB to be used to indicate the presence of an ‘extension MIB’ (eMIB, also referred to as additional MIB and/or MIB extension). For an existing 3GPP Rel-15 WD 22 and/or legacy WD 22, the bit is reserved and the WD 22 does not expect any specific value in the reserved bit. For a WD 22 implementing a future 3GPP Rel-X as at least partially defined herein, the reserved bit is used to indicate presence/absence of an ‘extension MIB’, e.g., a 0 in the reserved bit indicates no eMIB such that the WD 22 reinterprets/interprets the MIB in a predefined way such as according to existing wireless communication standards such as 3GPP Rel-15 specifications, and 1 in the reserved bit indicates the presence of an eMIB as described herein. As used herein 3GPP Rel-X may refer to one or more future releases of 3GPP wireless communication standards that are at least partially defined according to the teachings described herein.

The eMIB may be transmitted such as via one or more of processing circuitry 68, processor 70, radio interface 62, MIB unit 32, etc. in a manner invisible to legacy WDs 22. To avoid specifying additional physical channel structure, it may be preferable to reuse the existing PBCH structure or even the whole synchronization signal block (SSB) structure. Making the eMIB invisible to legacy WDs 22 can be achieved by, for example, such as via one or more of processing circuitry 68, processor 70, radio interface 62, MIB unit 32, etc., using a different scrambling sequence than the current MIB or by using a different cyclic redundancy check (CRC) than the current MIB to ensure that legacy WDs 22 are not able to mistakenly decode the eMIB as a regular MIB. If the SSB structure is reused, a different primary synchronization signal (PSS) and/or secondary synchronization signal (SSS), with values not representing a valid combination according to current specifications, can be used to avoid legacy WDs 22 detecting and/or decoding the eMIB.

The PSS/SSS may not be needed for the eMIB and hence the resource elements occupied by these signals can be reused for other purposes. In particular, the PSS/SSS would be the same SS block as the eMIB if the eMIB was transmitted in an SS block analogous to the SS block in which the MIB was transmitted. Alternatively, the eMIB can be transmitted such as via one or more of processing circuitry 68, processor 70, radio interface 62, MIB unit 32, etc. using a smaller number of OFDM symbols than currently used for the SSB. The transmission timing of the eMIB can be defined in relation to the current MIB, e.g. using the next possible MIB occasion for the eMIB.

In another embodiment, the reserved bit in the MIB may be used to indicate reinterpretation of one or more existing fields in the MIB or interpretations of one or more existing fields in the MIB in a predefined way such as a predefined way different from way/manner if the indication was not present in the reserved bit. In such an embodiment, for a 3GPP Rel-15 WD 22, the bit is reserved and the WD 22 does not expect any specific value, i.e., the WD 22 behaves in a predefined “ordinary” way such as according to the current, i.e., known, 3GPP MIB specifications. For a future 3GPP Rel-X WD 22 (i.e., a WD 22 implementing a future 3GPP Rel-X), the reserved bit is used to indicate if one or more existing fields in the MIB are to be reinterpreted and/or interpreted in a predefined way, e.g., a 0 in the reserved bit indicates no reinterpretation and operation otherwise according to existing wireless communication standards such as 3GPP Rel-15 specifications as in the case for “ordinary” MIB, and a 1 in the reserved bit indicates reinterpretation and/or interpretation of MIB in a predefined way different from the interpretation of “ordinary” MIB. For example, pdcch-ConfigSIB1 in an existing communications standard may be configured to indicate a CORESET (i.e., CORESET #0) and PDCCH time domain location/monitoring occasion (i.e., Search Space #0) where the indication can be redefined for 3GPP Rel-X WD 22. In such an embodiment, if the reserved bit in the MIB is 0, pdcch-ConfigSIB1 bears the same meaning (i.e., is interpreted in a first predefined way) for a 3GPP Rel-X WD 22 as for a 3GPP Rel-15 WD 22 such that, for example, the WD 22 uses CORESET #0 and Search Space #0 as defined in existing communication standards such as 3GPP Rel-15. If the reserved bit in the MIB is 1, pdcch-ConfigSIB1 may bear a different meaning (i.e., is interpreted and/or defined in a second predefined way different from the first predefined way) for a 3GPP Rel-X WD 22 than from a 3GPP Rel-15 WD 22. For example, in this case where the reserved bit in the MIB is equal to 1, pdcch-ConfigSIB1 may indicate another CORESET #0 (e.g., with reduced bandwidth such as when compared to CORESET #0 as may be defined in an existing communication standard) configuration and a new Search Space #0 (e.g. new monitoring occasion) configuration for the WD 22 to implement, i.e., MIB is interpreted in a predefined way different from another interpretation applicable to the MIB.

For backward capability, a network may need to transmit PDCCH scheduling SIB1 for 3GPP Rel-15 WD 22 per the configuration signaled in pdcch-ConfigSIB1. Effectively, the network node 16 needs to configure two CORESET #0's (resp. Search Space #0's) for scheduling SIB such as via one or more of processing circuitry 68, processor 70, radio interface 62, MIB unit 32, etc. This two CORSET #0 configuration may help accommodate reduced capability WDs 22 that have reduced bandwidth capability when compared to 3GPP Rel-15 WD 22. For example, the 3GPP Rel-15 WD 22 may interpret the field to receive a first CORESET #0 as is performed in existing WDs 22. However, a 3GPP Rel-X WD 22 may reinterpret the field as described herein to receive a second CORESET #0 that has a reduced bandwidth compared to the first CORESET #0. That is, in one or more embodiments, 3GPP Rel-X WD 22 may apply a different definition to interpret one or more field in the MIB, for example, based on the value of the reserved bit in the MIB.

In a third embodiment, no eMIB is used but the content of the MIB is interpreted in a predefined way and/or reinterpreted as compared to the existing, i.e., known, version of the 3GPP specifications (without involving the new functionality of the reserved bit that is described above). For example, the table of CORESET #0 configuration can be replaced by a new one, defined for a future release of the NR specifications. In one or more embodiments, the one or more tables, configurations, etc. maybe stored by WD 22 such as in memory 88 and/or received from the network node 16 via signaling. To avoid legacy WDs 22 potentially finding this MIB and using the MIB, with a potential wrong understanding of the content, several possibilities exist. For example, in some embodiments, a different PBCH scrambling sequence, a different PBCH CRC, or a different PSS/SSS structure than the current SSB can be used.

### Some Examples

Example A1. A network node 16 configured to communicate with a wireless device 22 (WD 22), the network node 16 configured to, and/or comprising a radio interface 62 and/or comprising processing circuitry 68 configured to, at least one of:

use a reserved bit of a master information block (MIB) transmitted to the WD 22 as an indication of at least one of the presence of an extended MIB (eMIB) and an instruction to reinterpret at least a portion of content of the MIB; and

replace at least a portion of the MIB with content coded in conformance with a second communication standard that is different than content coded in conformance with a first communication standard of the MIB.

Example A2. The network node 16 of Example A1, configured to, and/or comprising a radio interface 62 and/or comprising processing circuitry 68 configured to transmit the eMIB such that the eMIB is not detectable by a legacy WD 22.

Example A3. The network node 16 of any one of Examples A1 and A2, configured to, and/or comprising a radio interface 62 and/or comprising processing circuitry 68 configured to use at least one of a different physical broadcast channel (PBCH) scrambling sequence than the MIB and a different PBCH cyclic redundancy check (CRC) than the current MIB.

Example A4. The network node 16 of any one of Examples A1-A3, configured to, and/or comprising a radio interface 62 and/or comprising processing circuitry 68 configured to, if a synchronization signal block (SSB) structure is reused, use a different at least one of a primary synchronization signal (PSS) and a secondary synchronization signal (SSS) with values not representing a valid combination according to a specification of the MIB.

Example A5. The network node 16 of any one of Examples A1-A4, configured to, and/or comprising a radio interface 62 and/or comprising processing circuitry 68 configured to define a transmission timing of the eMIB in relation to the MIB.

Example A6. The network node 16 of any one of Examples A1-A5, configured to, and/or comprising a radio interface 62 and/or comprising processing circuitry 68 configured to use a next possible MIB occasion for the eMIB.

Example A7. The network node 16 of any one of Examples A1-A6, configured to, and/or comprising a radio interface 62 and/or comprising processing circuitry 68 configured to repurpose resource elements occupied by at least one of a PSS and an SSS.

Example A8. The network node 16 of any one of Examples A1-A7, configured to, and/or comprising a radio interface 62 and/or comprising processing circuitry 68 configured to transmit the eMIB using a smaller number of orthogonal frequency division multiplexing (OFDM) symbols than used for the SSB associated with the MIB.

Example B1. A method implemented in a network node 16, the method comprising at least one of:

using a reserved bit of a master information block (MIB) transmitted to the WD 22 as an indication of at least one of the presence of an extended MIB (eMIB) and an instruction to reinterpret at least a portion of content of the MIB; and

replacing at least a portion of the MIB with content coded in conformance with a second communication standard that is different than content coded in conformance with a first communication standard of the MIB.

Example B2. The method of Example B1, comprising transmitting the eMIB such that the eMIB is not detectable by a legacy WD 22.

Example B3. The method of any one of Examples B1 and B2, comprising using at least one of a different physical broadcast channel (PBCH) scrambling sequence than the MIB and a different PBCH cyclic redundancy check (CRC) than the MIB.

Example B4. The method of any one of Examples B1-B3, comprising, if a synchronization signal block (SSB) structure is reused, using a different at least one of a primary synchronization signal (PSS) and a secondary synchronization signal (SSS) with values not representing a valid combination according to a specification of the MIB.

Example B5. The method of any one of Examples B1-B4, comprising defining a transmission timing of the eMIB in relation to the MIB.

Example B6. The method of any one of Examples B1-B5, comprising using a next possible MIB occasion for the eMIB.

Example B7. The method of any one of Examples B1-B6, comprising repurposing resource elements occupied by at least one of a PSS or an SSS.

Example B8. The method of any one of Examples B1-B7, comprising transmitting the eMIB using a smaller number of orthogonal frequency division multiplexing (OFDM) symbols than used for the SSB associated with the MIB.

Example C1. A wireless device 22 (WD 22) configured to communicate with a network nod16e, the WD 22 configured to, and/or comprising a radio interface 82 and/or processing circuitry 84 configured to, at least one of:

use a reserved bit of a received master information block (MIB) as an indication of at least one of the presence of an extended MIB (eMIB) and an instruction to reinterpret at least a portion of content of the MIB; and decode at least a portion of the MIB content in conformance with a second communication standard that is different than a first communication standard used to decode at least a portion of the MIB content.

Example C2. The WD 22 of Example C1, configured to, and/or comprising a radio interface 82 and/or processing circuitry 84 configured to receive and decode the eMIB.

Example C3. The WD 22 of any one of Examples C1 and C2, configured to, and/or comprising a radio interface 82 and/or processing circuitry 84 configured to use at least one of a different physical broadcast channel (PBCH) scrambling sequence than the MIB and a different PBCH cyclic redundancy check (CRC) than the MIB.

Example C4. The WD 22 of any one of Examples C1-C3, configured to, and/or comprising a radio interface 82 and/or processing circuitry 84 configured to, if a synchronization signal block (SSB) structure is reused, use a different at least one of a primary synchronization signal (PSS) or a secondary synchronization signal (SSS) with values not representing a valid combination according to a specification of the MIB.

Example C5. The WD 22 of any one of Examples C1-C4, configured to, and/or comprising a radio interface 82 and/or processing circuitry 84 configured to decode a reception timing of the eMIB in relation to the MIB.

Example C6. The WD 22 of any one of Embodiments C1-C5, configured to, and/or comprising a radio interface 82 and/or processing circuitry 84 configured to interpret a subsequently received MIB as the eMIB.

Example C7. The WD 22 of any one of Examples C1-C6, configured to, and/or comprising a radio interface 82 and/or processing circuitry 84 configured to interpret resource elements occupied by at least one of a PSS or an SSS.

Example C8. The WD 22 of any one of Examples C1-C7, configured to, and/or comprising a radio interface 82 and/or processing circuitry 84 configured to receive the eMIB using a smaller number of orthogonal frequency division multiplexing (OFDM) symbols than used for the SSB associated with the MIB.

Example D1. A method implemented in a wireless device 22 (WD 22), the method comprising at least one of:

using a reserved bit of a master information block (MIB) received by the WD 22 as an indication of at least one of the presence of an extended MIB (eMIB) and an instruction to reinterpret at least a portion of content of the MIB; and

decoding at least a portion of the MIB content in conformance with a second communication standard that is different than a first communication standard of the MIB.

Example D2. The method of Example D1, comprising receiving and decoding the eMIB.

Example D3. The method of any one of Examples D1 and D2, comprising using at least one of a different physical broadcast channel (PBCH) scrambling sequence than the MIB and a different PBCH cyclic redundancy check (CRC) than the MIB.

Example D4. The method of any one of Examples D1-D3, comprising, if a synchronization signal block (SSB) structure is reused, using a different at least one of a primary synchronization signal (PSS) and a secondary synchronization signal (SSS) with values not representing a valid combination according to a specification of the MIB.

Example D5. The method of any one of Examples D1-D4, comprising decoding a reception timing of the eMIB in relation to the MIB.

Example D6. The method of any one of Examples D1-D5, comprising interpreting a subsequently received MIB as the eMIB.

Example D7. The method of any one of Examples D1-D6, comprising interpreting resource elements occupied by at least one of a PSS or an SSS.

Example D8. The method of any one of Examples D1-D7, comprising receiving the eMIB using a smaller number of orthogonal frequency division multiplexing (OFDM) symbols than used for the SSB associated with the MIB.

As will be appreciated by one of skill in the art, the concepts described herein may be embodied as a method, data processing system, computer program product and/or computer storage media storing an executable computer program. Accordingly, the concepts described herein may take the form of an entirely hardware embodiment, an entirely software embodiment or an embodiment combining software and hardware aspects all generally referred to herein as a “circuit” or “module.” Any process, step, action and/or functionality described herein may be performed by, and/or associated to, a corresponding module, which may be implemented in software and/or firmware and/or hardware. Furthermore, the disclosure may take the form of a computer program product on a tangible computer usable storage medium having computer program code embodied in the medium that can be executed by a computer. Any suitable tangible computer readable medium may be utilized including hard disks, CD-ROMs, electronic storage devices, optical storage devices, or magnetic storage devices.

Some embodiments are described herein with reference to flowchart illustrations and/or block diagrams of methods, systems and computer program products. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer (to thereby create a special purpose computer), special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable memory or storage medium that can direct a computer or other programmable data processing apparatus to function in a particular manner, such that the instructions stored in the computer readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

It is to be understood that the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved. Although some of the diagrams include arrows on communication paths to show a primary direction of communication, it is to be understood that communication may occur in the opposite direction to the depicted arrows.

Computer program code for carrying out operations of the concepts described herein may be written in an object oriented programming language such as Java® or C++. However, the computer program code for carrying out operations of the disclosure may also be written in conventional procedural programming languages, such as the “C” programming language. The program code may execute entirely on the user's computer, partly on the user's computer, as a stand-alone software package, partly on the user's computer and partly on a remote computer or entirely on the remote computer. In the latter scenario, the remote computer may be connected to the user's computer through a local area network (LAN) or a wide area network (WAN), or the connection may be made to an external computer (for example, through the Internet using an Internet Service Provider).

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

It will be appreciated by persons skilled in the art that the embodiments described herein are not limited to what has been particularly shown and described herein above. In addition, unless mention was made above to the contrary, it should be noted that all of the accompanying drawings are not to scale. A variety of modifications and variations are possible in light of the above teachings without departing from the scope of the following claims.

1. A wireless device configured to communicate with a network node, the wireless device comprising:
processing circuitry configured to:
receive master information block, MIB; and
use a bit of the MIB as at least one of an indication of presence of a MIB extension and as an instruction to interpret at least a portion of content of the MIB in a predefined way.

2. The wireless device of claim 1, wherein the bit is a reserved bit in the MIB.

3. The wireless device of claim 1, wherein the processing circuitry is configured to:
use the bit of the MIB as an indication of presence of the MIB extension; and
receive the MIB extension.

4. The wireless device of claim 3, wherein the processing circuitry is configured to receive the MIB extension in response to the bit of the MIB having a predefined value.

5. The wireless device of claim 3, wherein the MIB extension is an additional MIB and is received via a physical broadcast channel, PBCH.

6. (canceled)

7. (canceled)

8. The wireless device of claim 3, wherein the MIB defines a CORESET #0, and wherein the MIB extension defines a different CORESET #0 that has a smaller bandwidth than a bandwidth of the CORESET #0 defined by the MIB.

9. The wireless device of claim 3, wherein a size of the MIB extension is less than a size of the MIB.

10. The wireless device of claim 3, wherein a different scrambling sequence is used for the MIB extension than for the MIB.

11. The wireless device of claim 3, wherein a different CRC is used for the MIB extension than for the MIB.

12. The wireless device of claim 1, wherein the interpreting of at least the portion of content of the MIB in the predefined way includes at least one of:
interpreting at least the portion of content of the MIB in a first predefined way in response to the bit of the MIB having a first value; and
interpreting at least the portion of the content of the MIB in a second predefined way in response to the bit of the MIB having a second value.

13. A method implemented by a wireless device that is configured to communicate with a network node, the method comprising:
receiving master information block, MIB; and
using a bit of the MIB at least one of as an indication of presence of a MIB extension and as an instruction to interpret at least a portion of content of the MIB in a predefined way.

14. The method of claim 13, wherein the bit is a reserved bit in the MIB.

15. The method of claim 13, further comprising:
using the bit of the MIB as an indication of presence of the MIB extension; and
receiving the MIB extension.

16. (canceled)

17. The method of claim 15, wherein the MIB extension is an additional MIB and is received via a physical broadcast channel, PBCH.

18. (canceled)

19. (canceled)

20. The method of claim 15, wherein the MIB defines a CORESET #0 and wherein the MIB extension defines a different CORESET #0 that has a smaller bandwidth than a bandwidth of the CORESET #0 defined by the MIB.

21.-24. (canceled)

25. A network node configured to communicate with a wireless device, the network node comprising:
processing circuitry configured to cause transmission of master information block, MIB, a bit of the MIB providing at least one of an indication of presence of a MIB extension and an instruction to interpret at least a portion of content of the MIB in a predefined way.

26.-36. (canceled)

37. A method implemented by a network node that is configured to communicate with a wireless device, the method comprising causing transmission of master information block, MIB, a bit of the MIB providing at least one of an indication of presence of a MIB extension and an instruction to interpret at least a portion of content of the MIB in a predefined way.

38.-80. (canceled)

81. The wireless device of claim 8, wherein the bandwidth of the CORESET #0 defined by the MIB is at least 24 resource blocks, and wherein the bandwidth of the CORESET #0 defined by the MIB extension is less than 24 resource blocks.

82. The wireless device of claim 12, wherein the bit is a reserved bit in the MIB, wherein the portion of content of the MIB includes pdcch-ConfigSIB1, and wherein pdcch-ConfigSIB1 indicates a different CORESET #0 and a different Search Space #0 if the reserved bit in the MIB is 1 than if the reserved bit in the MIB is 0.

83. The method of claim 20, wherein the bandwidth of the CORESET #0 defined by the MIB is at least 24 resource blocks, and wherein the bandwidth of the CORESET #0 defined by the MIB extension is less than 24 resource blocks.
